(19) United States
(12) Patent Application Publication
(10) Pub. No.: US 2026/0362279 A1
(43) Pub. Date: Nov. 12, 2026

(54) METHOD FOR PERFORMING RADAR SENSING OF A MOBILE OBJECT ACROSS MULTIPLE CELL AREAS

(71) Applicant: Telefonaktiebolaget LM Ericsson (publ), Stockholm (SE)

(72) Inventors: Gabor FODOR, Hässelby (SE); Muhammad Ali KAZMI, Reston, VA (US)

(21) Appl. No.: 19/488,654

(22) PCT Filed: May 30, 2023
(86) PCT No.: PCT/SE2023/050534

§ 371 Date: Nov. 28, 2025

(51) Int. Cl. H04W 36/32; G01S 17/00; H04B 17/309; H04B 17/318

(52) U.S. Cl. CPC H04W 36/324; G01S 17/003; H04B 17/318; H04B 17/346

(57) ABSTRACT

A method, network node and wireless device (WD) for cell change are disclosed. According to one aspect, a method in a WD includes determining, by radar sensing, a mobility state of an object. The method also includes determining whether to perform a cell change to determine the mobility state of the object by a second network node based at least in part on a comparison of at least one mobility state parameter to a first threshold.

### TECHNICAL FIELD

The present disclosure relates to wireless communications, and in particular, to cell change. Methods, a first network node, a wireless device, computer program products, and computer programs are disclosed.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

Radio-based detection, ranging (radar), velocity estimation, positioning and radio communications share some common characteristics, since they exploit similar electromagnetic phenomena and have mechanisms to extract information from signals carried by electromagnetic waves. For example, a Doppler radar uses the Doppler effect to produce velocity data about objects at a distance. The radar typically uses the bouncing, backscattering or refraction and diffraction of the microwave signal off a desired target and analyzes how the object's motion has altered the frequency and phase of the returned signal.

However, there are significant differences in the operational requirements of radar and communication applications. Recently, the 3GPP has started studying use cases in which communication systems and communication signals are also used as basic means for radar sensing. In a future 3GPP architecture, monostatic, bi-static, and multi-static sensing are theoretically possible, and expected to be studied, as illustrated in FIG. 1. In FIG. 1, the suffix “-s” refers to sensing and indicates that these signals are for sensing rather than for communication purposes. However, it is possible to reuse communications signals as sensing signals. See, for example, “Enabling Joint Communications and Radar Sensing in Mobile Networks—a Survey,” IEEE Communications Surveys and Tutorials, Vol. 24, No. 1, First Quarter, 2022.

FIG. 1 illustrates different radar settings that may be deployed using cellular base stations (herein referred to as network node (NNs)) and wireless devices (WDs. Typically, the goal is to detect and localize a passive (non-connected) object of interest.

In FIG. 1 (a), “monostatic sensing” refers to the setting, for which the transmit sensing antenna array, denoted by TX-s, is co-located at the same physical node (here, the same base station) as the receiver sensing antenna array, denoted by RX-s. Note that monostatic sensing is possible using the Tx/Rx antennas at a WD as well.

In FIG. 1 (b), the bi-static setting corresponds to the case where the transmit sensing array antennas TX-s are located at a different node as compared to the receiver sensing antennas RX-s. For example, there may be bistatic sensing using a network node and a WD.

FIG. 1 (c) shows the multi-static case, for which several TX-s and several RX-s are present and they are all located at different nodes.

### Mobility Management and Handover Measurement Events

In LTE and NR systems, the WD conducts and reports a series of PHY layer measurements to the serving BS, such as reference signal received power (RSRP), reference signal received quality (RSRQ), signal to interference ratio (SNR) and received signal strength indicator (RSSI) on the NR carrier and the evolved universal terrestrial radio access (E-UTRA) carrier respectively. These measurements are classified as intra-frequency E-UTRA measurements, inter-frequency E-UTRA measurements and inter-radio access technology (inter-RAT) measurements in E-UTRA network system or as intra-frequency NR measurements, inter-frequency NR measurements and inter-radio access technology (inter-RAT) measurements in NR system. Based on the reported measurement values, their evolution in time, and several threshold values configured in network nodes, several handover measurement events are defined. For example, the A3 event indicates that a neighbor BS is becoming better than the currently serving BS in terms of received signal quality at the WD.

Measurement commands are used by NR and E-UTRA to instruct the WD to start/modify/stop various PHY layer measurements and associated reporting. The reporting criteria that are used include event-triggered reporting, periodic reporting, and event-triggered periodic reporting. In the RRC_CONNECTED state, network-controlled WD-assisted handovers are performed and various discontinuous reception (DRX) cycles are supported. In the RRC_IDLE state or RRC_INACTIVE state, where the DRX is always configured and used, the cell reselections are autonomously performed by the WD, e.g., based on the cell ranking which in turn is determined by the WD based on the PHY layer measurements performed by the WD.

Intra-E-UTRAN or intra-NR mobility support for mobile terminals handles the necessary steps for handover procedures, such as processes that precede the final handover decision on the serving network, preparation of resources on the target network, commanding the WD to the new radio resources, and finally releasing resources on the serving network side.

A problem with existing technology is that, although it supports the detection and tracking of highly mobile objects, existing technology does not support the tracking of mobile objects across multiple cell areas. A consequence of this is that as a mobile object moves out of the coverage area of a cell, the bounced or refracted radar signal on the object arrives at the radar receiver(s) with a low signal-to-noise ratio (SNR), resulting in poor detection and ranging estimation performance.

This problem arises in mono-static, bi-static, and multi-static scenarios, although the specific key performance indicators characterizing the sensing service may be different in these scenarios. For example, in a monostatic scheme (FIG. 1(a)), as the target object moves out of the coverage area, the SNR of the backscattered signal will likely be poor at the serving BS. In a bi-static scenario (FIG. 1(b)), due to the large distance between passive object and the BS of a connected WD, the received radar signal at another WD may have too low SNR for a sensing service.

### SUMMARY

An object of the invention is to facilitate sensing of an object in a communication network.

An object of some embodiments is to facilitate the cell change of an object. To achieve this object, sensing of a mobility state of the object is used to determine whether to perform a cell change from a first network node to a second network node to determine the mobility state of the object using the second network node.

Some embodiments include methods for detecting and tracking a passive object in the current cell (Cell-1), including determining the mobility state of the object (O1) e.g., velocity vector of O1. The mobility state such as velocity vector may be determined by a first network node, NN1 (mono-static case or bi-static case, where the first network node is the sensing signal receiving node), or by a first WD, WD1, served by the first network node in Cell-1 (e.g., bi-static case, where WD1 is a sensing signal receive node). Even if the WD1 is the receiving (RX) node for receiving the sensing/radar signals, the WD1 may report either the measured value of the radar signal (e.g., timing) or the determined position (e.g. geographical coordinates) and information about the mobility state of OB1 (e.g. velocity vector, direction of motion, acceleration) to NN1 of Cell1.

In some embodiments, the NN1 maintains a set of preconfigured threshold values for positions and mobility state of OB1 (e.g., velocity vectors). The pair or tuple of such threshold values define certain events, similarly to those defined for mobility management purposes in wireless access network e.g., in NR, EUTRA. These events, may trigger the “Passive Object HO preparation” message toward the estimated neighbor network node, NN2.

The handover of O1 may include three phases: 1) Measurement reporting and passive HO event evaluation, 2) Passive HO preparation and 3) HO execution.

In some embodiments, a set of PHY layer (radio) measurements and thresholds events are defined for tracking passive (non-connected) objects for the purpose of handing over the object to a new base station for sensing. Thus some embodiments include procedures to maintain the sensing service of a mobile passive object that moves across the coverage area of several cells.

An advantage of some embodiments is that the sensing service of a passive object is maintained without interruption as the object moves from the coverage area of an old cell to that of a new cell. If the passive object is, for example, a vulnerable road user, then it is vital that the object is tracked continuously without service interruption, as continuous tracking is needed to prevent accidents and provide reliable advanced driving assistance services (ADAS) to surrounding vehicles.

Another advantage of some embodiments is that the detection and tracking data is transferred from a serving network node to another network node. This information helps the new network node detect the arriving object in its coverage area more reliably and quickly than if such assistance information is not known beforehand.

According to one aspect, a method is performed by a first network node configured to communicate with a wireless device, WD. The method includes determining, by radar sensing, a mobility state of an object, the method also includes determining whether to perform a cell change to determine the mobility state of the object by a second network node based at least in part on a comparison of at least one mobility state parameter to a first threshold.

According to this aspect, in some embodiments, a mobility state parameter of the object includes at least one of a velocity of the object, a velocity vector of the object, an acceleration of the object, a direction of motion of the object and a trajectory of motion of the object. In some embodiments, a mobility state parameter of the object includes at least one of dimensions of the object and a type of the object. In some embodiments, the method includes handing over determining the mobility state of the object to the second network node 16 after the velocity points in a direction of the second network node 16 for at least N successive velocity determinations, N being an integer greater than 1. In some embodiments, the method includes handing over determining the mobility state of the object after at least one of a signal to noise ratio, SNR, and a received signal strength of a radar signal reflected by the object falls below a second threshold. In some embodiments, the method includes handing over determining the mobility state of the object when a distance between the first network node 16 and the object exceeds a third threshold. In some embodiments, the method includes handing over determining the mobility state of the object when a distance between the second network node 16 and the object falls below a third threshold. In some embodiments, the method includes configuring the second network node with at least one of a sensing signal reception pattern, SSRP, and a sensing signal transmission pattern, SSTP. In some embodiments, the radar sensing is monostatic. In some embodiments, the radar sensing is bi-static between the first network node and the WD. In some embodiments, the method includes initiating a configuration of the WD to engage in a bi-static radar sensing session with the second network node. In some embodiments, the method includes selecting a second WD to engage in a bi-static radar sensing session with the first network node. In some embodiments, the received signal level includes at least one of a received signal strength, RSS, a reference signal received power, RSRP, a signal to noise ratio, and a received signal quality, RSQ. In some embodiments, the method includes terminating determination of the mobility state of the object by the first network node 16 after the cell change.

According to another aspect, a first network node is configured to communicate with a wireless device, WD. The first network node includes processing circuitry configured to: determine, by radar sensing, a mobility state of an object; and determine whether to perform a cell change to determine the mobility state of the object by a second network node based at least in part on a comparison of the mobility state to a first threshold.

According to this aspect, in some embodiments, a mobility state parameter of the object includes at least one of a velocity of the object, a velocity vector of the object, an acceleration of the object, a direction of motion of the object and a trajectory of motion of the object. In some embodiments, a mobility state parameter of the object includes at least one of dimensions of the object and a type of the object. In some embodiments, the processing circuitry is configured to hand over determining the mobility state of the object to the second network node after the velocity points in a direction of the second network node for at least N successive velocity determinations, N being an integer greater than 1.

In some embodiments, the processing circuitry is configured to hand over determining the mobility state of the object after at least one of a signal to noise ratio, SNR, and a received signal strength of a radar signal reflected by the object falls below a second threshold. In some embodiments, the processing circuitry is configured to hand over determining the mobility state of the object after a distance between the first network node and the object exceeds a third threshold. In some embodiments, the processing circuitry is configured to hand over determining the mobility state of the object after a distance between the second network node and the object falls below a third threshold. In some embodiments, the processing circuitry is configured to configure the second network node with at least one of a sensing signal reception pattern, SSRP, and a sensing signal transmission pattern, SSTP.

According to yet another aspect, in some embodiments, a method is performed by a wireless device, WD, configured to communicate with a first network node. The method includes one of receiving and transmitting a radar sensing signal reflected from an object that is being tracked in a bi-static radar sensing session between the WD and the first network node. The method also includes receiving a cell change command; and executing the cell change command to continue to track the object in a bi-static radar sensing session between the WD and a second network node.

According to this aspect, in some embodiments, the method includes at least one of receiving a radar sensing signal from the second network node after being reflected by the object and transmitting a radar sensing signal to the second network node 16. In some embodiments, the method includes assisting the second network node 16 to track the object. In some embodiments, the cell change command includes an indication of at least one of a sensing signal reception pattern, SSRP, and a sensing signal transmission pattern, SSTP, reserved by the second network node 16. In some embodiments, executing the cell change command includes terminating the bi-static radar sensing session between the WD and the first network node in response and commencing a second bi-static radar sensing session between the WD and the second network node. In some embodiments, the method includes transmitting to at least one of the first network node and the second network node an acknowledgement of the cell change command. In some embodiments, the method includes transmitting to the first network node an indication of an inability to track the object.

According to another aspect, a WD is configured to communicate with a first network node. The WD includes a radio interface configured to: one of receive and transmit a radar sensing signal reflected from an object that is being tracked in a bi-static radar sensing session between the WD and the first network node; and receive a cell change command. The process also includes processing circuitry in communication with the radio interface and configured to execute the cell change command to continue to track the object in a bi-static radar sensing session between the WD and a second network node.

According to this aspect, in some embodiments, the radio interface is further configured to receive a radar sensing signal from the second network node after being reflected by the object. In some embodiments, the processing circuitry is further configured to assist the second network node to track the object. In some embodiments, the cell change command includes an indication of at least one of a sensing signal reception pattern, SSRP, and a sensing signal transmission pattern, SSTP, reserved by the second network node. In some embodiments, executing the cell change command includes terminating the bi-static radar sensing session between the WD and the first network node in response and commencing a second bi-static radar sensing session between the WD and the second network node. In some embodiments, the processing circuitry is configured to transmit to at least one of the first network node and the second network node an acknowledgement of the cell change command. In some embodiments, the processing circuitry is configured to transmit to the first network node an indication of an inability to track the object.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates monostatic, bistatic and multi-static sensing scenarios;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a network node for cell change based on mobility state of an object;

FIG. 9 is a flowchart of an example process in a wireless device for cell change based on mobility state of an object;

FIG. 10 illustrate a cell change operation in a bistatic sensing scenario;

FIG. 11 is a process for performing a cell change operation in a bistatic sensing scenario;

FIG. 12 illustrates a cell change operation in a monostatic sensing scenario;

FIG. 13 is a process for performing a cell change operation in a monostatic sensing scenario;

FIG. 14 is an example of a computer program product and a computer program; and

FIG. 15 is an example of a processing system configured to store a computer program product and execute a computer program of the computer program product.

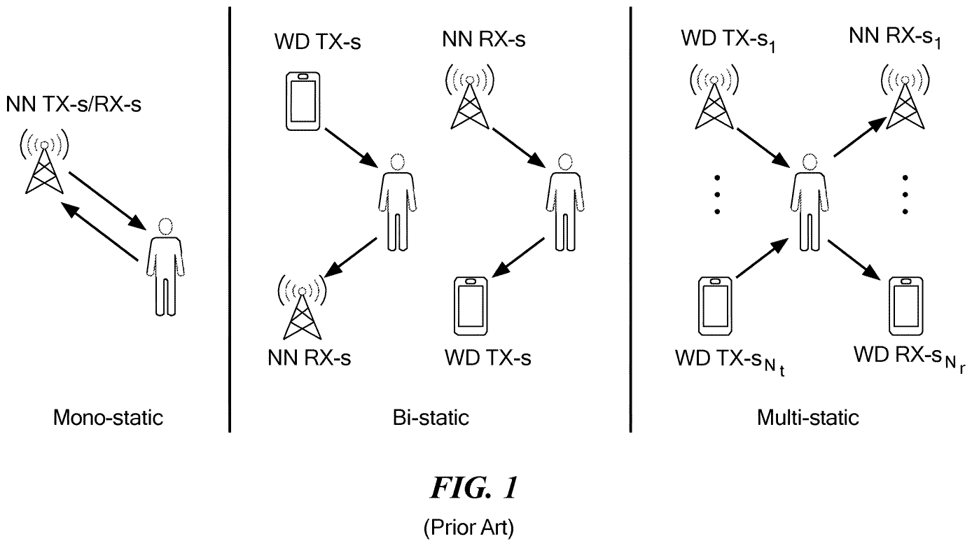

### DETAILED DESCRIPTION

Before describing in detail example embodiments, it is noted that the embodiments reside primarily in combinations of apparatus components and processing steps related to cell change based on mobility state of an object. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system.

Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide procedures for cell change based on mobility state of an object, where the object is initially tracked by a first network node and then, after handover to a second network node, the object is tracked by the second network node. In a bistatic case, some embodiments provide for handover from a first wireless device (WD) and a first network node to a second WD and a second network node.

The term passive object (O1) refers to any item or thing (e.g., human, vehicle, airborne object, etc.), which does not process any sensing or radar signal operated by a radio node (e.g., WD, base station, etc.). The term processing a sensing/radar signal may refer to any one or more of the following: reception of the sensing/radar signal from a radio node, transmission of the sensing/radar signal to a radio node, measurements on the sensing/radar signal, performing one or computations (e.g., correlation, addition, subtraction, etc.) on the sensing/radar signal, amplification of the sensing/radar signal etc. However, the sensing/radar signal which impinges on O1 may be reflected or deflected in any direction with the same or reduced power compared to the received power when the sensing signal strikes O1. O1 may also partially or fully absorbed the sensing/radar signal falling on O1. The radio node (e.g., NN 16, WD 22, etc.) may receive the sensing/radar signal reflected or deflected by O1 depending on the received signal level of the received sensing/radar signal. Examples of the received signal level are signal strength, signal quality etc. Examples of the signal strength are RSRP, path loss etc. Examples of the signal quality are RSRQ, SNR, SINR, etc.

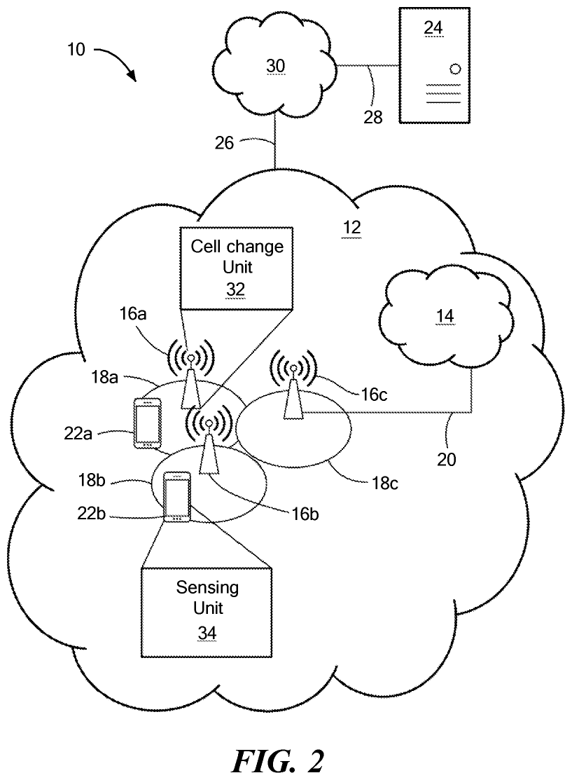

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a cell change unit 32 which is configured to determine whether to perform a cell change to determine the mobility state of the object 94 by a second network node based at least in part on a comparison of the mobility state to a first threshold. A wireless device 22 is configured to include a sensing unit 34 which is configured to track the object 94 in a bi-static radar sensing session between the WD and a second network node.

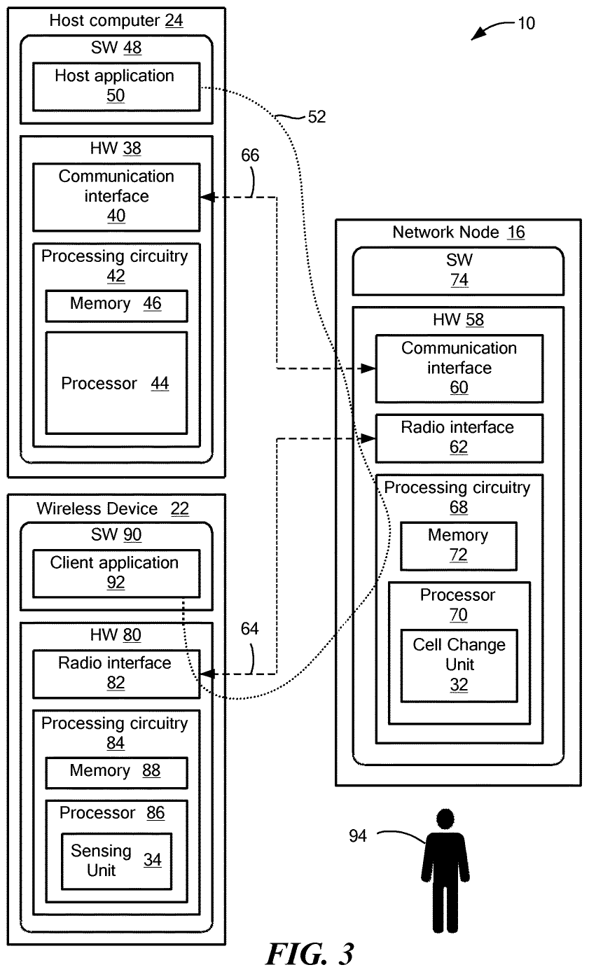

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a cell change unit 32 which is configured to determine whether to perform a cell change to determine the mobility state of the object 94 by a second network node based at least in part on a comparison of the mobility state to a first threshold.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a sensing unit 34 which is configured to track the object 94 in a bi-static radar sensing session between the WD and a second network node. In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc. ; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as cell change unit 32 and sensing unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

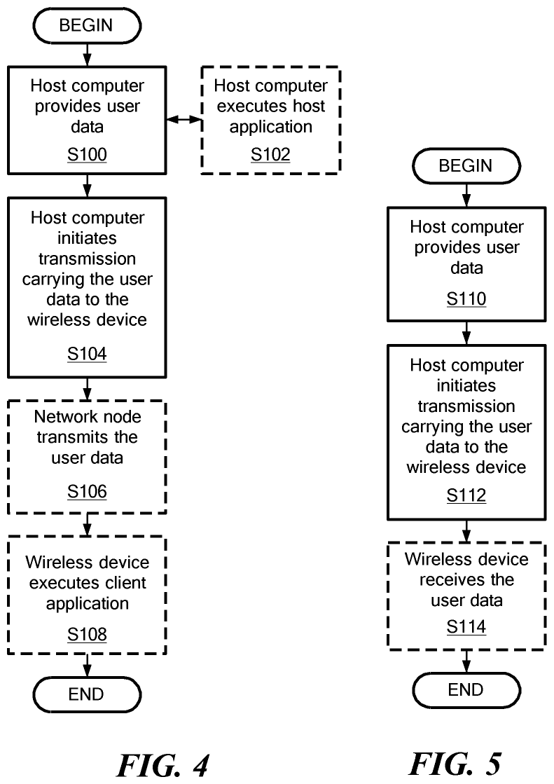

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

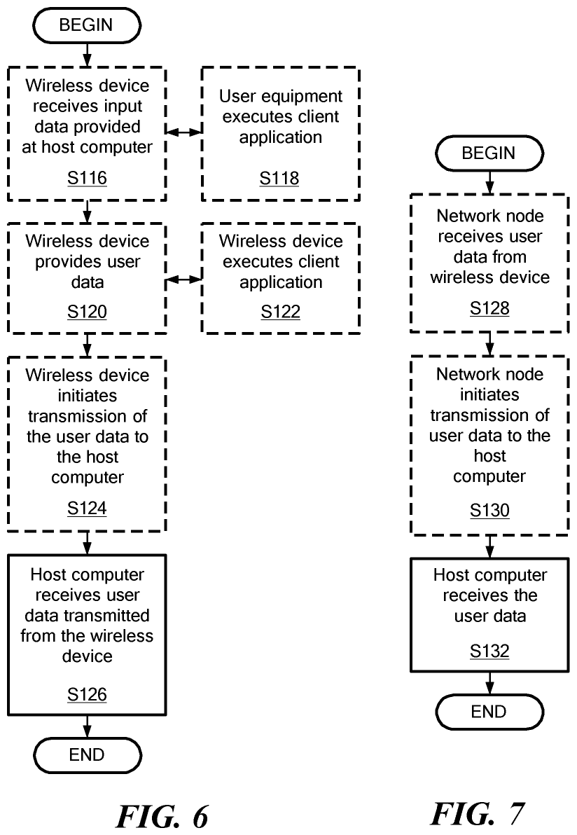

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

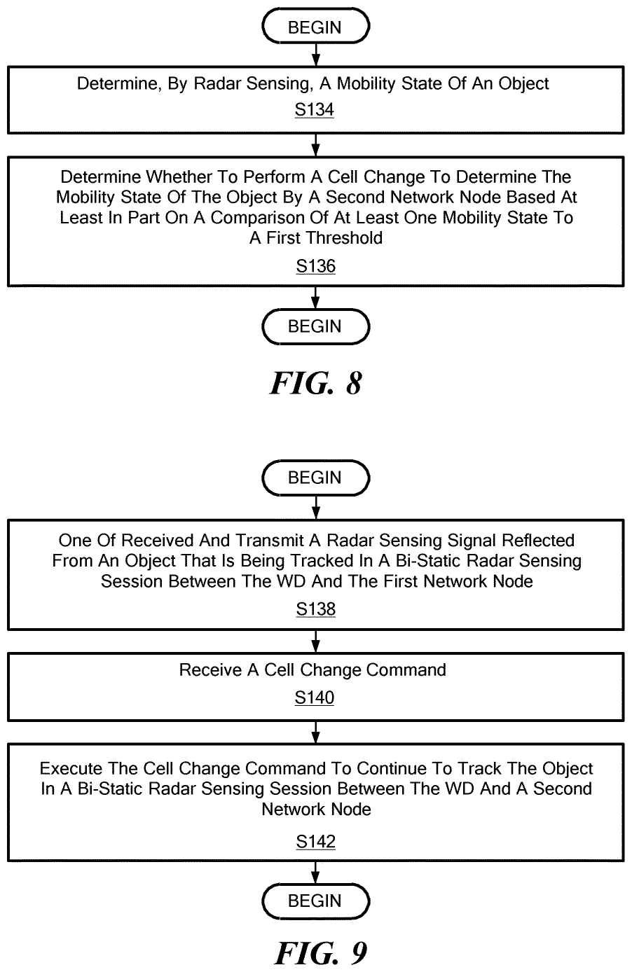

FIG. 8 is a flowchart of an example process in a network node 16 for cell change based on mobility state of an object 94. One or more blocks described herein may be performed by one or more elements of network node 16 such as by one or more of processing circuitry 68 (including the cell change unit 32), processor 70, radio interface 62 and/or communication interface 60. Network node 16 such as via processing circuitry 68 and/or processor 70 and/or radio interface 62 and/or communication interface 60 is configured to determine, by radar sensing, a mobility state of an object 94 (Block S134).

The process also includes determining whether to perform a cell change to determine the mobility state of the object 94 by a second network node 16 based at least in part on a comparison of at least one mobility state parameter to a first threshold (Block S136).

In some embodiments, a mobility state parameter of the object 94 includes at least one of a velocity of the object 94, a velocity vector of the object 94, an acceleration of the object 94, a direction of motion of the object 94 and a trajectory of motion of the object 94. In some embodiments, a mobility state parameter of the object 94 includes at least one of dimensions of the object 94 and a type of the object 94. In some embodiments, the method includes handing over determining the mobility state of the object 94 to the second network node 16 after the velocity points in a direction of the second network node 16 for at least N successive velocity determinations, N being an integer greater than 1. In some embodiments, the method includes handing over determining the mobility state of the object 94 after at least one of a signal to noise ratio, SNR, and a received signal strength of a radar signal reflected by the object 94 falls below a second threshold. In some embodiments, the method includes handing over determining the mobility state of the object 94 when a distance between the first network node 16 and the object 94 exceeds a third threshold. In some embodiments, the method includes handing over determining the mobility state of the object 94 when a distance between the second network node 16 and the object 94 falls below a third threshold. In some embodiments, the method includes configuring the second network node 16 with at least one of a sensing signal reception pattern, SSRP, and a sensing signal transmission pattern, SSTP. In some embodiments, the radar sensing is monostatic. In some embodiments, the radar sensing is bi-static between the first network node 16 and the WD 22. In some embodiments, the method includes initiating a configuration of the WD 22 to engage in a bi-static radar sensing session with the second network node 16. In some embodiments, the method includes selecting a second WD 22 to engage in a bi-static radar sensing session with the first network node 16. In some embodiments, the received signal level includes at least one of a received signal strength, RSS, a reference signal received power, RSRP, a signal to noise ratio, and a received signal quality, RSQ. In some embodiments, the method includes terminating determination of the mobility state of the object 94 by the first network node 16 after the cell change.

FIG. 9 is a flowchart of an example process in a wireless device 22 according to some embodiments of the present disclosure. One or more blocks described herein may be performed by one or more elements of wireless device 22 such as by one or more of processing circuitry 84 (including the sensing unit 34), processor 86, radio interface 82 and/or communication interface 60. Wireless device 22 such as via processing circuitry 84 and/or processor 86 and/or radio interface 82 is configured to one of receive and transmit a radar sensing signal reflected from an object 94 that is being tracked in a bi-static radar sensing session between the WD 22 and the first network node 16 (Block S138). The process also includes receiving a cell change command (Block S140). The process also includes executing the cell change command to continue to track the object 94 in a bi-static radar sensing session between the WD 22 and a second network node 16 (Block S142).

In some embodiments, the method includes at least one of receiving a radar sensing signal from the second network node 16 after being reflected by the object 94 and transmitting a radar sensing signal to the second network node 16. In some embodiments, the method includes assisting the second network node 16 to track the object 94. In some embodiments, the cell change command includes an indication of at least one of a sensing signal reception pattern, SSRP, and a sensing signal transmission pattern, SSTP, reserved by the second network node 16. In some embodiments, executing the cell change command includes terminating the bi-static radar sensing session between the WD 22 and the first network node 16 in response and commencing a second bi-static radar sensing session between the WD 22 and the second network node 16. In some embodiments, the method includes transmitting to at least one of the first network node 16 and the second network node 16 an acknowledgement of the cell change command. In some embodiments, the method includes transmitting to the first network node 16 an indication of an inability to track the object 94.

Having described the general process flow of arrangements of the disclosure and having provided examples of hardware and software arrangements for implementing the processes and functions of the disclosure, the sections below provide details and examples of arrangements for cell change based on mobility state of an object 94.

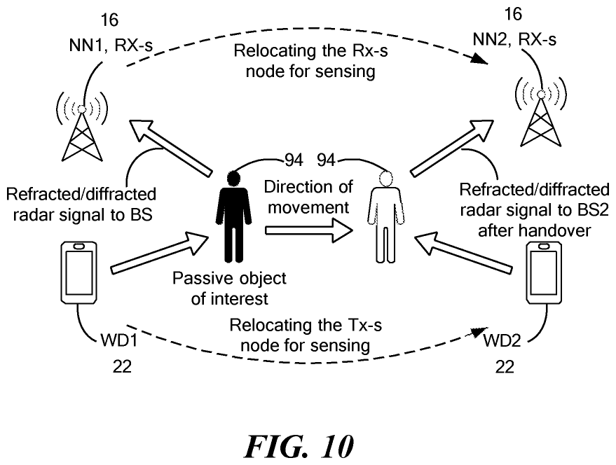

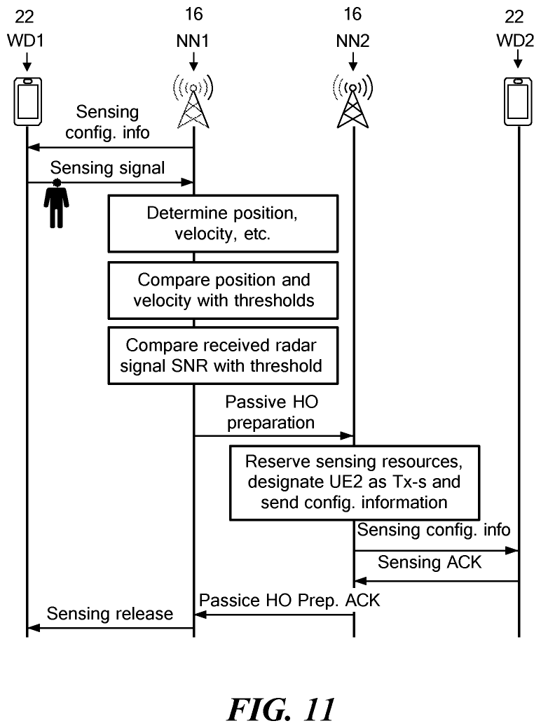

FIGS. 10 and 11 show an example of a bi-static sensing scenario, in which WD1 22 acts as TX-s sensing transmitter node, while NN1 16 is the RX-s sensing receiver node. NN1 16 serves or manages or operates a first Cell (Cell1). Cell is the serving cell of WD1 22, e.g., PCell. In this case, the passive object 94 moves towards Cell-2, and the refracted/diffracted/reflected/scattered signal, bouncing off the passive object 94 (O1) allows NN1 16 to determine its position and mobility state (e.g., velocity, direction of motion (e.g., azimuth angle, zenith angle, etc.), change in direction of motion, acceleration, trajectory of motion, etc.). For example, NN1 16 may determine the location and/or the mobility state of O1 by observing, estimating or measuring one or more of, for example, a change in the received signal level (e.g., RSRP, RSRQ, path loss, etc.), angle of arrival, variation in angle of arrival etc., of the sensing signal received at NN1 16 after it has been refracted/diffracted/reflected/scattered by O1. NN1 16 may also obtain information about the location and/or the mobility state of O1 from another node or server. For example, the server may be a logical and/or physical entity, which may be third party node and which post processes the measurements on radar signal received from WDs 22 and/or NNs 16. The server may further use the measurement results and may combine with additional information (e.g., still images, etc.) to keeps track of location and/or mobility state of the passive objects in the vicinity.

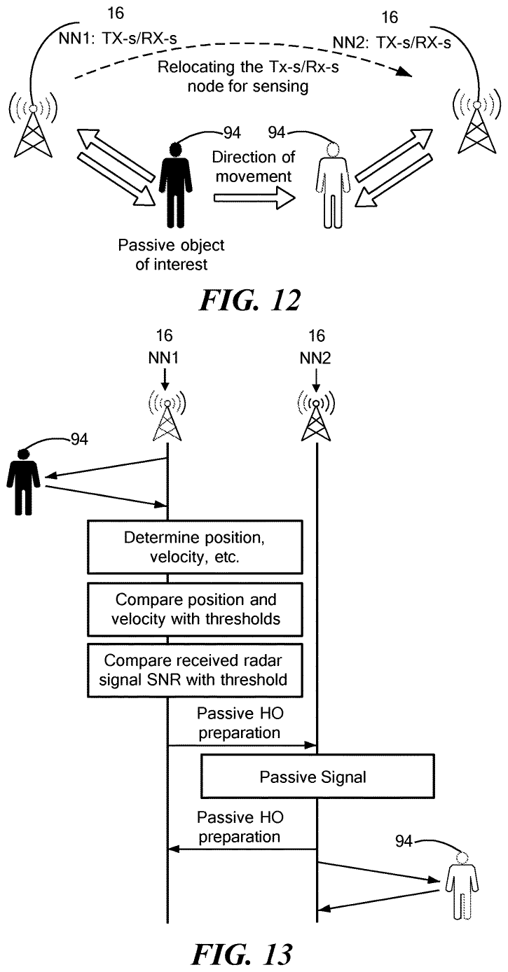

As the passive object 94 moves, one or more of the following events and signaling message exchanges may take place according to some embodiments (see FIGS. 10 and 11):
1. NN1 16 may keep track of the changes in the passive object's position and mobility state (e.g., velocity vector). The NN1 16 may update its determination of the mobility state at regular intervals. If the determined mobility state of O1 such as the velocity vector points in the direction of NN2 16 in the past N updates, and the position of the passive object 94 is closer to NN2 16 than a predefined threshold, NN1 16 may transmit a “Passive HO preparation” command to NN2 16. Other triggering criterion for sending the “Passive HO preparation” command to NN2 16 may include detecting low received signal level (e.g., low SNR, low RSRQ, etc.) for the received sensing signal or the position being such that the absolute distance between the passive object 94 and NN2 16 is less than the distance between the object 94 and NN1 16. NN1 16 and NN2 16 may or may not be co-located at the same physical site or location. The term handover or passive handover may refer to any type of cell change for the passive object 94, e.g., when NN1 16 and NN2 16 operate Cell1 and Cell2 respectively on the same carrier or different carriers, or on the carriers of the same or different radio access technologies (RATs);
2. The “Passive HO preparation” command may contain optional parameters about the passive object 94. These may include but are not limited to:
   a. one or more mobility state related parameters (e.g., the velocity vector, acceleration, direction of motion, change in direction of motion, etc.), current position, and if available, the 3-dimensional (3D) size of the object 94 (e.g., any one or more of radius, diameter, height, width, breadth, size compared to or relative to a size of a reference object 94, etc.). The reference object size may be pre-defined or configured by a network node 16, etc. ;
   b. type of object 94, e.g., whether the object 94 is estimated to be a vehicle, a human, an airborne object 94 such as a drone or aerial vehicle such as helicopter, etc. ; and/or
   c. Other parameters may relate to the characteristics of the sensing signal and the sensing resources that WD1 22 and NN1 16 are currently using. Examples of such parameters may include information (e.g., start timing, periodicity, etc.) about a sensing signal transmission pattern (SSTP), information about a sensing signal reception pattern (SSRP), numerology of the sensing signal, cyclic prefix (CP) length, subcarrier spacing, slot length, symbol duration, bandwidth of the sensing signal, number of resource blocks (RBs), sensing signal transmission power, sensing signal beam direction, type of reference signal (for example, a synchronization signal block (SSB) used as sensing signal, etc. SSTP and/or SSRP may be periodic, aperiodic or semi-persistent;
3. When NN2 16 receives the “Passive HO preparation” command and associated parameters, it reserves resources for sensing signal transmission and/or reception in a second cell (Cell2). NN2 16 serves or manages or operates a second Cell (Cell2). NN2 16 may further transmit information about the resources reserved for sensing signal sensing signal transmission and/or reception in Cell2, to NN1 16:
   a In one example, NN1 16 may configure WD1 22 to receive the sensing signal from NN2 16 and/or transmit the sensing signal if one or more signal conditions between WD1 22 and Cell2 are met. NN1 16 may further configure WD1 22 with information about the SSRP and/or SSTP reserved in Cell2. For example, the signal condition may be met if the received signal level at the WD with respect to Cell2 is within an acceptable value, e.g., if the signal level (e.g., RSRP) is above a threshold. NN1 16 may determine this based on a measurement report of a measurement (e.g., RSRP, RSRQ, etc.) performed on Cell2 transmitting by WD1 22 to NN1 16;
   b. In another example, NN2 16 may select a second WD (WD2) for sensing transmission or reception. (Note that in FIG. 10, WD2 22 is a TX-s node, but other configurations, in which WD2 22 is n RX-s node are also possible.) WD2 22 may be served by Cell2. The signal level of WD2 22 may be above certain threshold. Selecting WD2 22 may be based on predefined criteria, related to WD2 22 capability, current position and WD2 22 mobility state (e.g., velocity vector, direction of motion, acceleration, etc.); and/or
   c. NN1 16 and/or NN2 16 may further exchange signaling messages to determine whether to use WD1 22 and/or WD2 22 for transmission and/or reception of the sensing signals operated by Cell2 after the passive handover of the object 94. The determination may be based on one or more criteria. Examples of criteria include:
      i. WD whose received signal level (e.g., RSRP, RSRQ, etc.) with respect to Cell2 is largest is selected;
      ii. WD1 22 is not selected and WD2 22 is selected if WD1 22 cannot perform sensing in Cell2 while being served by Cell1, for example when WD1 22 is not capable of it and WD1 22 currently does not have sufficient resources, etc. ; and/or
      iii. WD1 22 is selected provided that transmission of the sensing signal by WD1 22 in Cell2 does not cause interference in Cell1 more than certain threshold. Otherwise WD2 22 may be selected;
4. After selecting WD2 22, NN2 16 may signal to WD2 22 that WD2 22 is requested to participate in an upcoming signaling session. Also, NN2 16 may send sensing configuration information, such as sensing Tx/Rx resources, sensing pattern in time/frequency resources, as well as information about the current state of the passive object 94, such as its current mobility state (e.g., velocity, direction of motion, etc.) and position (e.g., geographical coordinates);
5. WD2 22 may acknowledge the sensing configuration. WD2 22 may also request the NN2 16 to change its role between TX-S and RX-S;
6. NN2 16 signals to NN1 16 “Passive HO Preparation ACK”. This is an input to NN1 16 regarding the final decision of terminating tracking of the passive object 94. Alternatively, NN1 16 may continue tracking the passive object 94 until NN2 16 reporting that the object 94 is successfully tracked in Cell-2; and/or
7. As illustrated in FIGS. 12 and 13, a similar procedure is applicable in the mono-static case, in which NN1 16 acts as a monostatic radar. Note that some embodiments are also applicable for a case in which the NN1 16 performs monostatic sensing in Cell-1, whereas NN2 16 and WD2 22 may act as bi-static radar in Cell-2 after the passive HO procedure.

As will be appreciated by one of skill in the art, the concepts described herein may be embodied as a method, data processing system, computer program product and/or computer storage media storing an executable computer program.

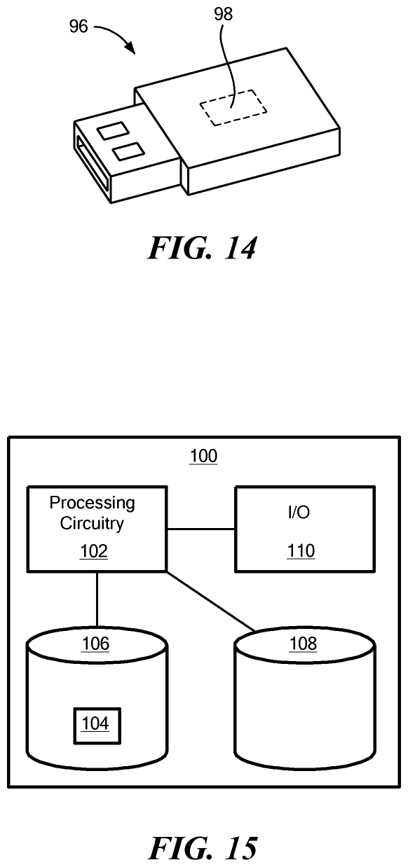

FIG. 14 shows one example of a computer program product 96 comprising computer readable means. On this computer readable means, a computer program 98 can be stored in a non-transitory memory. The computer program can cause processing circuitry to execute a method according to embodiments described herein. In this example, the computer program product 96 is in the form of a removable solid-state memory, e.g. a Universal Serial Bus (USB) drive. As explained above, the computer program product could also be embodied in a memory of a device. While the computer program 98 is schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

FIG. 15 is a schematic diagram illustrating components of a processing system 100 configurable to read the computer program 98 and execute instructions of the computer program 98, according to one embodiment. Processing system 100 may include all or a part of the corresponding elements of network node 16 and/or wireless device 22 shown in FIG. 3 or may be implemented in other system elements. Processing circuitry 102 is provided using any combination of one or more of a suitable central processing unit (CPU), graphics processing unit (GPU), multiprocessor, neural processing unit (NPU), microcontroller, digital signal processor (DSP), etc. capable of executing software instructions 104 stored in a memory 106, which can thus be a computer program product 96. The processing circuitry 102 could alternatively be implemented using an application specific integrated circuit (ASIC), field programmable gate array (FPGA), etc. The processing circuitry 102 can be configured to execute embodiments of the methods described herein. The processing circuitry may also be configured to access remote, local or other memory 108 which may include operating system instructions. The memory 106 and/or memory 108 can be any combination of random-access memory (RAM) and/or read-only memory (ROM). The memory 106 may also comprise non-transitory persistent storage, which, for example, can be any single one or combination of magnetic memory, optical memory, solid-state memory or even remotely mounted memory. The processing circuitry 102 may also be in communication with an input/output (I/O) interface 110 to enable user interaction with the processing system 100. Thus, some embodiments include a computer program product 96 and a computer program 98 and a computer readable means comprising non-transitory memory in which the computer program 98 is stored. The computer program 98 includes computer instructions that when executed by a processor, causes the processor to perform any of the methods disclosed herein.

Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
EPHR Extended Power Headroom Report
JCAS Joint communication and sensing
EPHR Extended PHR
HO Handover
NN Network Node
PCell Primary Cell
PUSCH Physical Uplink Shared Channel
RSRP Reference Signal Received Power
PHR Power Headroom Report
PSCell Primary Secondary Cell
SPHR Sensing PHR
SCell Secondary Cell
SFN System Frame Number
SL Sidelink
SNR Signal to Noise Ratio
SpCell Special Cell
UE User Equipment
UL Uplink
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method performed by a first network node configured to communicate with a wireless device, WD, the method comprising:
determining, by bi-static radar sensing between the first network node and the WD, a mobility state of an object; and
determining whether to perform a cell change to determine the mobility state of the object by a second network node based at least in part on a comparison of at least one mobility state parameter to a first threshold.

2.-14. (canceled)

15. A first network node configured to communicate with a wireless device, WD, the first network node comprising processing circuitry configured to:
determine, by bi-static radar sensing between the first network node and the WD, a mobility state of an object; and
determine whether to perform a cell change to determine the mobility state of the object by a second network node based at least in part on a comparison of the mobility state to a first threshold.

16. The first network node of claim 15, wherein a mobility state parameter of the object includes at least one of a velocity of the object, a velocity vector of the object, an acceleration of the object, a direction of motion of the object and a trajectory of motion of the object.

17. The first network node of claim 15, wherein a mobility state parameter of the object includes at least one of dimensions of the object and a type of the object.

18. The first network node of Claim 15, wherein the processing circuitry is configured to hand over determining the mobility state of the object to the second network node after the velocity points in a direction of the second network node for at least N successive velocity determinations, N being an integer greater than 1.

19. The first network node of claim 15, wherein the processing circuitry is configured to hand over determining the mobility state of the object after at least one of a signal to noise ratio, SNR, and a received signal strength of a radar signal reflected by the object falls below a second threshold.

20. The first network node of claim 15, wherein the processing circuitry is configured to hand over determining the mobility state of the object after a distance between the first network node and the object exceeds a third threshold.

21. The first network node of claim 15, wherein the processing circuitry is configured to hand over determining the mobility state of the object after a distance between the second network node and the object falls below a third threshold.

22. The first network node of claim 15, wherein the processing circuitry is configured to configure the second network node with at least one of a sensing signal reception pattern, SSRP, and a sensing signal transmission pattern, SSTP.

23.-24. (canceled)

25. The first network node of claim 15, wherein the processing circuitry is configured to configure the WD to engage in a bi-static radar sensing session with the second network node.

26. The first network node of claim 15, wherein the processing circuitry is configured to select a second WD to engage in a bi-static radar sensing session with the first network node.

27. The first network node claim 15, wherein the received signal level includes at least one of a received signal strength, RSS, a reference signal received power, RSRP, a signal to noise ratio, and a received signal quality, RSQ.

28. The first network node claim 15, wherein the processing circuitry is configured to cease determining of the mobility state of the object using the first network node after the cell change.

29. A method performed by a wireless device, WD, configured to communicate with a first network node, the method comprising:
one of receiving and transmitting a radar sensing signal reflected from an object that is being tracked in a bi-static radar sensing session between the WD and the first network node; and
receiving a cell change command; and
executing the cell change command to continue to track the object in a bi-static radar sensing session between the WD and a second network node.

30.-35. (canceled)

36. A wireless device, WD, configured to communicate with a first network node, the WD comprising:
a radio interface configured to:
one of receive and transmit a radar sensing signal reflected from an object that is being tracked in a bi-static radar sensing session between the WD and the first network node; and
receive a cell change command; and
processing circuitry in communication with the radio interface and configured to execute the cell change command to continue to track the object in a bi-static radar sensing session between the WD and a second network node.

37. The WD of claim 36, wherein the radio interface is further configured to receive a radar sensing signal from the second network node after being reflected by the object.

38. The WD of claim 36, wherein the processing circuitry is further configured to assist the second network node to track the object.

39. The WD of claim 36, wherein the cell change command includes an indication of at least one of a sensing signal reception pattern, SSRP, and a sensing signal transmission pattern, SSTP, reserved by the second network node.

40. The WD of claim 36, wherein executing the cell change command includes terminating the bi-static radar sensing session between the WD and the first network node in response and commencing a second bi-static radar sensing session between the WD and the second network node.

41. The WD of claim 36, wherein the processing circuitry is configured to transmit to at least one of the first network node and the second network node an acknowledgement of the cell change command.

42.-46. (canceled)
